(19) United States
(12) Patent Application Publication
(10) Pub. No.: US 2011/0005001 A1
(43) Pub. Date: Jan. 13, 2011

(54) Detergent Composition

(76) Inventors: Eric San Jose Robles, Newcastle upon Tyne (GB); Alan Thomas Brooker, Newcastle upon Tyne (GB); Nigel Patrick Somer Ville Roberts, Newcastle upon Tyne (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/820,310

(22) Filed: Jun. 22, 2010

Related U.S. Application Data
(60) Provisional application No. 61/224,157, filed on Jul. 9, 2009.

(51) Int. Cl. C11D 3/36; C11D 7/42; D06L 1/04

(52) U.S. Cl. 8/137; 510/340; 510/321

(57) ABSTRACT

Detergent composition having:
from 2 to 30% by weight of anionic surfactants,
from 0 to 7% of linear alkylbenzene sulfonate(s),
from 0 to 7% of alkyl sulfate(s),
from 0 to 2% of fatty acids,
from 0 to 5% of phosphate builder,
from 0 to 15% of aluminosilicate builder,
   wherein the weight ratio of linear alkylbenzene sulfonate(s) to the total amount of anionic surfactant can be between 0 and 0.65,
   wherein the weight ratio of alkyl sulfate(s) to the total amount of anionic surfactant can be between 0 and 0.65.

### CROSS REFERENCE TO RELATED APPLICATION

This application claims the benefit of U.S. Provisional Application Ser. No. 61/224,157, filed Jul. 9, 2009.

### TECHNICAL FIELD

The present invention relates to a detergent composition comprising a plurality of anionic surfactants. the invention also relates to a method of laundering soiled fabrics in an automatic washing machine wherein part of the anionic surfactants of the aqueous laundering solution are present in the aqueous laundering solution at a concentration below the solubility product constant of the corresponding calcium anionic surfactant.

### BACKGROUND OF THE INVENTION

The process of cleaning, in particular the process of laundering fabric typically involves the preparation of a wash liquor, in particular an aqueous laundering solution, by mixing a detergent composition with water, in particular tap water.

The water used in the preparation of the wash liquor typically has a level of hardness due in particular to the presence of calcium ions. Hardness is typically considered to have a negative effect on some chemistry used in detergent composition and may for example have a detrimental effect on the detergency of anionic surfactants.

As a consequence, the detergent compositions will typically comprise a high level of builders, such as phosphate builders or zeolite builders, to bind to or precipitate with the calcium ion and remove free hardness present in the wash liquor.

The level of free hardness in the wash liquor is difficult to control. This level will depends of the quantity and the choice of the builders in the detergent composition. The level of free hardness will also depend heavily of the initial level of hardness of the water, of the quantity of water used during the wash, and of the quantity of detergent composition used.

However, the detergency of anionic surfactant, as well as the performances of other chemistry such as enzymes, is not optimal if the level of calcium ions in the wash liquor is too low.

The consumer will not always have the knowledge of the hardness of the water and the quantity of product to use to have an optimal level of builder in the wash liquor. Anyway, the consumer will typically rather optimize the level of anionic surfactant, which depends of the quantity of cleaning required, than optimize the level of builder in the wash liquor.

Because the water hardness and the optimal level of anionic surfactant may vary greatly, the detergent composition typically comprises a level of builder which is adapted to the most stringent condition such as low concentration of detergent composition in the wash liquor and high level of hardness in the water. When such detergent compositions are used at higher concentration and/or in water having a lower level of hardness, this will results in a large excess of builders, leading to a level of calcium ions in the wash liquor too low to optimize the performance of the anionic surfactants.

As such, there is a need for a detergent composition having an optimized performance of calcium dependant technology in a wider variety of wash condition.

### SUMMARY OF THE INVENTION

In one embodiment of the present invention, the invention concerns a detergent composition comprising:

from 2 to 30% by weight of anionic surfactants,

from 0 to 7% of linear alkylbenzene sulfonate(s),

from 0 to 7% of alkyl sulfate(s),

from 0 to 2% of soap,

from 0 to 5% of phosphate builder,

from 0 to 15% of aluminosilicate builder,

wherein the weight ratio of linear alkylbenzene sulfonate(s) to the total amount of anionic surfactant is comprised between 0 and 0.65,

wherein the weight ratio of alkyl sulfate(s) to the total amount of anionic surfactant is comprised between 0 and 0.65.

The inventors have surprisingly found that it was possible to formulate detergent composition with an optimized detergency of the anionic surfactants in a broad range of wash conditions by using a plurality of anionic surfactants and thus limiting the individual concentration of each anionic surfactant, in particular anionic surfactants having a low solubility product constant of the corresponding calcium anionic surfactant.

This also allows the use of a lower quantity of builders, in particular builders having a high affinity for calcium, which further broaden the range of wash conditions in which the detergency of the anionic surfactant is optimized.

In one embodiment of the present invention, the invention concerns a method of laundering fabric in an automatic washing machine, which method comprises the steps of:
a) forming an aqueous laundering solution by mixing from 1 l to 40 l of water and a solid detergent composition comprising a surfactant system containing anionic surfactants, said aqueous laundering solution comprising from 200 ppm to 5,000 ppm of the detergent composition;
b) putting in contact soiled fabrics with said aqueous laundering solution; and
c) washing said fabrics in said solution,
wherein during the washing step c), at least 90% by weight of the anionic surfactants of the aqueous laundering solution are present in the aqueous laundering solution at a concentration below the solubility product constant of the corresponding calcium anionic surfactant.

Unless otherwise specified, the percentage and ratio in the claims and the present specification are by weight.

### DETAILED DESCRIPTION OF THE INVENTION

### Anionic Surfactant

The detergent composition of the invention comprises from 2% to 30% by weight of anionic surfactants. The detergent composition may comprise 3% to 25%, in particular from 4% to 20% or from 5% to 18%, or even from 6% to 16% or from 7% to 14% by weight of anionic surfactants.

At least 90% by weight of the anionic surfactants of the detergent composition may be present in a concentration such that they will not substantially precipitate with calcium ions in an aqueous laundering solution consisting of at most 200 ppm, in particular of at most 500 ppm or 1000 ppm or 2000 ppm or 5000 ppm of the detergent composition in 11 of water at 40° C. having a hardness of at most 3 gpg, in particular at most 6 gpg, in particular of at most 12 gpg (calcium magnesium ratio of 3:1).

In particular, the anionic surfactant may comprise anionic surfactants selected from alkyl ester sulfonate(s); linear, branched, and modified alkylbenzene sulfonate(s); C₁₀-C₁₈ alkyl alkoxy sulfates; C₁₀₋₂₀ primary, branched-chain and random alkyl sulfates; C₁₀-C₁₈ secondary (2,3) alkyl sulfates; C₁₀-C₁₈ alkyl alkoxy carboxylate(s); fatty acid(s); mid-chain branched alkyl sulfate(s); mid-chain branched alkyl alkoxy sulfate(s); alpha-olefin sulfonate(s); phosphate ester(s); and mixtures thereof.

### Alkyl Ester Sulfonate Surfactant (“MES”)

As used herein, “MES” refers to alkyl ester sulfonate surfactants, commonly used in methyl ester sulfonate form. MES surfactants useful herein include sulfonated fatty acid alkyl esters of the formula R—CH(SO3⁻)—COOR′, wherein R is, on the average, a C₆ to C₂₂ alkyl and R′ is on the average a C₁ to C₈ alkyl.

The hydrophobic portion of these sulfonated alkyl esters have the sulfonate group at the α-position, i.e., the sulfonate group is positioned at the carbon atom adjacent to the carbonyl group. The alkyl portion of the hydrophobic portion, which corresponds to the R portion of the sulfonated fatty acid alkyl esters, is on the average a C₆ to C₂₂ alkyl. Preferably, the alkyl portion of this hydrophobic portion, R, has a straight-chain of an average length C₈ to C₁₆ hydrocarbon particularly when R′ is methyl.

R′, forming the ester portion of the sulfonated alkyl esters, is on the average a Cᵢ to C₈ alkyl. Preferably, R′ is on the average a C₁ to C₆ alkyl, and most preferably a Cᵢ alkyl, i.e., methyl.

In one embodiment, the distribution is such that R is, on the average, a C₁₄ to C₁₆ alkyl (approximately, for example, a 95% C₁₄, 5% C₁₆ mixture) and R′ is methyl. In another embodiment, the distribution is such that R is, on the average, a C₁₂ to C₁₆ alkyl (approximately, for example, a 3% C₁₂, 28% C₁₄, 69% C₁₆ mixture) and R′ is methyl. In yet another embodiment, the distribution is such that R is, on the average, a C₁₀ to C₁₆ alkyl (approximately, for example, a 60% C₁₀, 35% C₁₂, 5% C₁₄ mixture) and R′ is methyl. In yet a further embodiment, blends of the aforementioned distributions of R and R′ may also be employed. In one embodiment, the methyl ester sulfonate has an average carbon length of about 16. In other embodiments, R′ could be ethyl (C₂), n-propyl & i-propyl (C₃), n-butyl, i-butyl (C₄), n-pentyl (C₅) and n-hexyl (C₆).

Methods of making alkyl ester surfactants neutralized with an alkali metal or an alkaline earth metal have been well described and are known to those skilled in art the art. See, for example, U.S. Pat. Nos. 4,671,900; 4,816,188; 5,329,030; 5,382,677; 5,384,422; 5,475,134; 5,587,500; 6,780,830. MES as such is commercially available from Huish.

The detergent composition of the invention may comprise from 0% to 7%, in particular from 0.5% to 6% or from 1% to 5% or from 1.5% to 4% or from 2% to 3% by weight of Alkyl Ester Sulfonate Surfactant. The detergent composition may comprise from 0% to 7%, in particular from 0.5% to 6% or from 1% to 5% or from 1.5% to 4% or from 2% to 3% by weight of sulfonated fatty acid alkyl esters of the formula R—CH(SO3⁻)—COOR′, wherein R is, on the average, a C₆ to C₂₂ alkyl and R′ is on the average a C₁ to C₈ alkyl. The detergent composition may comprise from 0 to 4% in particular less than 3% or less than 2% or less than 1% or even less than 0.5% by weight of alkyl esters of the formula R—CH(SO3⁻)—COOCH₃, wherein R is a C₁₄ alkyl. The detergent composition may comprise from 0 to 4% in particular less than 3% or less than 2% or less than 1% or even less than 0.5% by weight of alkyl esters of the formula R—CH(SO3⁻)—COOCH₃, wherein R is a C₁₋₆ alkyl.

### Linear, Branched, and Modified Alkylbenzene Sulfonate

The detergent composition may comprise alkyl benzene sulfonates which includes linear or branched alkyl benzene sulfonates. The detergent composition may comprise from 0% to 12% or from 0 to 7%, in particular from 0.5% to 6% or from 1% to 5% or from 1.5% to 4% or from 2% to 3% by weight of alkyl benzene sulfonates. The detergent composition comprises from 0% to 7%, in particular from 0.5% to 6% or from 1% to 5% or from 1.5% to 4% or from 2% to 3% by weight of linear alkyl benzene sulfonates. The detergent composition may comprise from 0% to 7%, in particular from 0.5% to 6% or from 1% to 5% or from 1.5% to 4% or from 2% to 3% by weight of branched alkyl benzene sulfonates.

The weight ratio of linear alkylbenzene sulfonate(s) the total amount of anionic surfactant is comprised between 0 and 0.65, preferably between 0.1 and 0.5 or from 0.2 and 0.4.

The weight ratio of alkylbenzene sulfonate(s) the total amount of anionic surfactant is comprised between 0 and 0.65, preferably between 0.1 and 0.5 or from 0.2 and 0.4.

Exemplary anionic surfactants are C₁₀₋₁₆ alkyl benzene sulfonates, preferably C₁₁₋₁₄ alkyl benzene sulfonates. In one embodiment, the alkyl group is linear and such linear alkyl benzene sulfonates are known as “LAS”. Alkyl benzene sulfonates, and particularly LAS, are well known in the art. Such surfactants and their preparation are described for example in U.S. Pat. Nos. 2,220,099 and 2,477,383. Preferred are the linear straight chain alkylbenzene sulfonates in which the average number of carbon atoms in the alkyl group is from about 11 to 14. Particularly, C₁₁-C₁₄, e.g., C₁₂, and LAS is a specific example of such surfactants.

The detergent composition may comprise from 0 to 4% in particular less than 3% or less than 2% or less than 1% or even less than 0.5% by weight of C₁₁ LAS. The detergent composition may comprise from 0 to 4% in particular less than 3% or less than 2% or less than 1% or even less than 0.5% by weight of C₁₂ LAS. The detergent composition may comprise from 0 to 4% in particular less than 3% or less than 2% or less than 1% or even less than 0.5% by weight of C₁₃ LAS. The detergent composition may comprise from 0 to 4% in particular less than 3% or less than 2% or less than 1% or even less than 0.5% by weight of C₁₄ LAS.

Other exemplary alkylbenzene sulfonates include modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548. The detergent composition may comprise from 0% to 7%, in particular from 0.5% to 6% or from 1% to 5% or from 1.5% to 4% or from 2% to 3% by weight of MLAS.

MLAS may comprise a mixture, preferably consisting essentially of: (a) from about 15% to about 99%, preferably from about 15% to about 60%, more preferably from about 20% to about 40%, by weight of a mixture of branched alkylbenzene sulfonates having formula:

L(R1)(R2)-A-SO₃⁻

wherein L is an acyclic aliphatic moiety consisting of carbon and hydrogen, the L having two methyl termini and the L having no substituents other than A, R¹ and R²; and wherein the mixture of branched alkylbenzene sulfonates contains two or more, preferably at least three, optionally more, of the branched alkylbenzene sulfonates differing in molecular weight of the anion of the formula (I), and wherein the mixture of branched alkylbenzene sulfonates has a sum of carbon atoms in R¹, L and R² of from 9 to 15, preferably from 10 to 14; an average aliphatic carbon content, i.e., based on R′, L and R² and excluding A, of from about 10.0 to about 14.0, preferably from about 11.0 to about 13.0, more preferably from about 11.5 to about 12.5, carbon atoms; R¹ is C₁-C₃ alkyl, preferably C₁-C₂ alkyl, more preferably methyl; R² is selected from H and C₁-C₃ alkyl, preferably H and C₁-C₂ alkyl, more preferably H and methyl, more preferably H and methyl provided that in at least about 0.5, more preferably 0.7, more preferably 0.9 to 1.0 mole fraction of the branched alkylbenzene sulfonates, R² is H; A is a benzene moiety, typically A is the moiety-C₆H₄—, with the SO₃⁻ moiety of Formula (I) in para-position to the L moiety, though in some proportion, usually no more than about 5%, preferably from 0 to 5% by weight, the SO₃⁻ moiety is ortho- to L; and (b) from about 1% to about 85%, preferably from about 40% to about 85%, more preferably from about 60% to about 80%, by weight of a mixture of nonbranched alkylbenzene sulfonates having formula:

Y-A-SO₃⁻

wherein A is as defined hereinbefore and Y is an unsubstituted linear aliphatic moiety consisting of carbon and hydrogen having two methyl termini, and wherein the Y has a sum of carbon atoms of from 9 to 15, preferably from 10 to 14, and the Y has an average aliphatic carbon content of from about 10.0 to about 14.0, preferably from about 11.0 to about 13.0, more preferably 11.5 to 12.5 carbon atoms; and wherein the modified alkylbenzene sulfonate surfactant mixture is further characterized by a ⅔-phenyl index of from about 160 to about 275, preferably from about 170 to about 265, more preferably from about 180 to about 255; and also preferably wherein the modified alkylbenzene sulfonate surfactant mixture has a 2-methyl-2-phenyl index of less than about 0.3, preferably less than about 0.2, more preferably less than about 0.1, more preferably still, from 0 to 0.05.

### Alkyl Sulfate

The composition of the invention comprises from 0% to 7% of alkyl sulfate(s). When present, the alkyl sulfate(s) may be chosen among Mid-chain Branched Alkyl Sulfates, Mid-chain Branched Alkyl Alkoxy Sulfates, C₁₀-C₁₈ Alkyl Alkoxy Sulfates, C₁₀₋₂₀ Primary, Branched-Chain and Random Alkyl Sulfates, C₁₀-C₁₈ Secondary (2,3) Alkyl Sulfates and mixtures thereof. Alkyl sulfates may be added separately to the compositions of this invention and used as or in any anionic surfactant component which may be present.

The weight ratio of alkyl sulfate(s) the total amount of anionic surfactant is comprised between 0 and 0.65, preferably between 0.1 and 0.5 or from 0.2 and 0.4.

### Mid-chain Branched Alkyl Sulfates

The detergent composition may comprise from 0% to 7%, in particular from 0.5% to 6% or from 1% to 5% or from 1.5% to 4% or from 2% to 3% by weight of mid-chain branched alkyl sulfates as discussed in U.S. Pat. Nos. 6,020,303 and U.S. Pat. No. 6,060,443.

### Mid-chain Branched Alkyl Alkoxy Sulfates

The detergent composition may comprise from 0% to 7%, in particular from 0.5% to 6% or from 1% to 5% or from 1.5% to 4% or from 2% to 3% by weight of mid-chain branched alkyl alkoxy sulfates as discussed in U.S. Pat. Nos. 6,008,181 and U.S. Pat. No. 6,020,303.

### C₁₀-C₁₈ Alkyl Alkoxy Sulfates

The detergent composition may comprise ethoxylated alkyl sulfate surfactants. Such materials, also known as alkyl ether sulfates or alkyl polyethoxylate sulfates may correspond to the formula:

R′—O—(C₂H₄O)ₙ—SO₃⁻

wherein R′ is a C₈-C₂₀ alkyl group and n is from about 1 to 20. In a specific embodiment, R′ is C₁₀-C₁₈ alkyl and n is from about 0.1 to 15. In another embodiment, n is from about 1 to 15. In more specific embodiments, R′ is a C₁₂-C₁₆, n is from about 1 to 6. In the disclosure herein, the designation “EOx” indicates that the alkoxy group is an ethoxy group, the integer “x” indicates the number of ethoxy groups in each chain.

The alkyl ether sulfates will generally be used in the form of mixtures comprising varying R′ chain lengths and varying degrees of ethoxylation. Frequently, though the average n value may be more than zero, such mixtures will inevitably also contain some non-ethoxylated alkyl sulfate materials, i.e., individual surfactant molecules of the above ethoxylated alkyl sulfate formula wherein n=0 for that particular molecule. The detergent composition may comprise from 0% to 7%, in particular from 0.5% to 6% or from 1% to 5% or from 1.5% to 4% or from 2% to 3% by weight of ethoxylated alkyl sulfate surfactants.

### C₁₀₋₂₀ Primary, Branched-Chain and Random Alkyl Sulfates

Specific examples of alkyl sulfates surfactants are those produced by the sulfation of higher C₁₀-C₂₀ fatty alcohols. Conventional primary alkyl sulfate surfactants have the general formula:

ROSO₃⁻

wherein R is typically a linear C₁₀-C₂₀ alkyl group, which may be straight chain or branched chain. In specific embodiments, R is a C₁₀-C₁₅ alkyl, more specifically R is C₁₂-C₁₄.

The detergent composition may comprise from 0% to 7%, in particular from 0.5% to 6% or from 1% to 5% or from 1.5% to 4% or from 2% to 3% by weight of primary alkyl sulfate surfactants having the general formula ROSO₃⁻ wherein R is a linear C₁₀-C₂₀. The detergent composition may comprise from 0 to 4% in particular less than 3% or less than 2% or less than 1% or even less than 0.5% by weight of primary alkyl sulfate surfactants having the general formula C₁₂—OSO₃⁻. The detergent composition may comprise from 0 to 4% in particular less than 3% or less than 2% or less than 1% or even less than 0.5% by weight of primary alkyl sulfate surfactants having the general formula C₁₄—OSO₃⁻. The detergent composition may comprise from 0 to 4% in particular less than 3% or less than 2% or less than 1% or even less than 0.5% by weight of primary alkyl sulfate surfactants having the general formula C₁₆—OSO₃⁻. C₁₀-C₁₈ Secondary (2,3) Alkyl Sulfates

The detergent composition may comprise from 0% to 7%, in particular from 0.5% to 6% or from 1% to 5% or from 1.5% to 4% or from 2% to 3% by weight of secondary (2,3) alkyl sulfates having formulae CH₃—(CH₂)ₓ—CH(OSO₃⁻)—CH₃ or CH₃—(CH₂)_{y}—CH(OSO₃⁻)—CH₂—CH₃.

Non-limiting examples of a preferred secondary alkyl sulfate include the one where x is at least about 7, preferably at least about 9, and y is an integer of at least 8, preferably at least about 9.

### C₁₀-C₁₈ Alkyl Alkoxy Carboxylates

The detergent composition may comprise from 0% to 7%, in particular from 0.5% to 6% or from 1% to 5% or from 1.5% to 4% or from 2% to 3% by weight of ethoxylated alkyl carboxylate surfactants. Such materials, also known as alkyl ether carboxylates or alkyl polyethoxylate carboxylates, are those which correspond to the formula:

R′—O—(C₂H₄O)ₙ—COO⁻

wherein R′ is a C₈-C₂₀ alkyl group and n is an integer from about 1 to 20. In a specific embodiment, R′ is C₁₀-C₁₈ alkyl and/or n is from about 1 to 15. In more specific embodiments, R′ is a C₁₂-C₁₆ and/or n is from about 1 to 6.

The alkyl ether carboxylates will generally be used in the form of mixtures comprising varying R′ chain lengths and varying degrees of ethoxylation. Frequently such mixtures will inevitably also contain some non-ethoxylated alkyl carboxylate materials, i.e., surfactants of the above alkyl ether carboxylate formula wherein n=0.

### Fatty Acids

The detergent composition of the invention comprise from 0% to 2%, preferably less than 1.5% or less than 1% or less than 0.5% or 0.2% of fatty acids and soaps. Fatty acids have the general formula:

RCOO⁻

wherein R is typically a C₉-C₂₁ alkyl group, which may be straight chain or branched chain. In specific embodiments, R is a C₉-C₁₇ alkyl, and more specifically R is C₁₁-C₁₅. the fatty acids, when present, may be saturated or unsaturated, preferably unsaturated.

Exemplary fatty acids are selected from the group consisting of lauric acid, tridecylic acid, myristic acid, pentadecylic acid, palmitic acid, margaric acid, stearic acid, arachidic acid, phytanic acid, behenic acid, palmitoleic acid, oleic acid, elaidic acid, vaccenic acid, linoleic acid, cis-eleostearic acid, trans-eleosteric acid, linolenic acid, arachidonic acid and combinations thereof. Preferred fatty acids can be saturated or unsaturated. Unsaturated fatty acids typically having an iodine value from 15 to 25, preferably from 18 to 22 and a cis:trans isomer ratio from 1:1 to 200:1, preferably fro 10:1 to 200:1.

The sources of fatty acid may be selected from the group consisting of coconut, soybean, tallow, palm, palm kernel, rapeseed, lard, sunflower, corn, safflower, canola, olive, peanut and combinations thereof.

### Alpha-Olefin Sulfonate

The detergent composition may comprise from 0% to 7%, in particular from 0.5% to 6% or from 1% to 5% or from 1.5% to 4% or from 2% to 3% by weight of olefin sulfonates, which are compounds produced by the sulfonation of alpha-olefin by means of uncomplexed sulfur trioxide followed by neutralization of the acid reaction mixture under conditions such that sultones formed in the reaction are hydrolyzed to give corresponding hydroxyalkanesulfonates. The alpha-olefins from which the olefin sulfonates are derived are mono-olefins having from about 8 to about 24 carbon atoms, preferably from about 14 to about 16 carbon atoms. They may be straight chain olefins. Exemplary alpha-olefin sulfonates for use in the disclosure herein have the general formula:

R—CH═CH—CH2—SO₃⁻ (2,3-alkenylsulfonate) or R—CH(OH)—CH2—CH2—SO₃⁻ (3-hydroxy-alkanesulfonate,

where R is a linear or branched alkyl of about 8 to 20 carbon atoms. Examples of suitable alpha-olefins include 1-olefins such as 1-dodecene, 1-tetradecene, 1-hexadecene, 1-octadecene, 1-eicosene and 1-tetracosene.

### Phosphate Esters

The detergent composition may comprise from 0% to 7%, in particular from 0.5% to 6% or from 1% to 5% or from 1.5% to 4% or from 2% to 3% by weight of phosphate esters. Phosphate esters are any materials of the general formula:

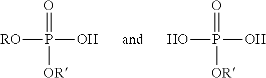

wherein R and R′ are C₆-C₂₀ alkyl or ethoxylated alkyl groups. Preferably R and R′ are of the general formula:

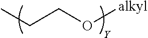

wherein the alkyl substituent is C₁₂-C₁₈ and Y is between 0 and about 4. Most preferably the alkyl substituent of that formula is C₁₂-C₁₈ and Y is between about 2 and about 4. Such compounds may be prepared by known methods from phosphorus pentoxide, phosphoric acid, or phosphorus oxy halide and alcohols or ethoxylated alcohols.

It will be appreciated that the formula depicted represent mono- and di-esters, and commercial phosphate esters will generally comprise mixtures of the mono- and di-esters, together with some proportion of tri-ester.

Builder

The detergent composition of the invention may comprise a builder. When a builder is used, the detergent composition will typically comprise from 1% to about 40%, typically from 2 to 20%, or even from about 4% to about 15%, or from 5 to 10% by weight of builder(s).

The composition may further comprise from 1% to about 40%, typically from 2 to 20%, or even from about 4% to about 15%, or from 5 to 10% by weight of builder(s), chelant(s), or, in general, any material which will remove calcium ions from solution by, for example, sequestration, complexation, precipitation or ion exchange.

The composition may comprise a chelant. Suitable chelants include diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid). A preferred chelant is ethylene diamine-N′N′-disuccinic acid (EDDS) and/or hydroxyethane diphosphonic acid (HEDP). Preferably the ethylene diamine-N′N′-disuccinic acid is in S′S′ enantiomeric form. The composition of the invention may comprise less than 3% or less than 2% or 1% or 0.5% of each of the above mentioned chelants.

Builders include, but are not limited to, the alkali metal, ammonium and alkanolammonium salts of polyphosphates, alkali metal silicates, layered silicates, such as SKS-6 of Clariant®, alkaline earth and alkali metal carbonates, aluminosilicate builders, such as zeolite, and polycarboxylate compounds, ether hydroxypolycarboxylates, copolymers of maleic anhydride with ethylene or vinyl methyl ether, 1, 3, 5-trihydroxy benzene-2,4,6-trisulphonic acid, and carboxymethyloxysuccinic acid, fatty acids, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

The detergent composition comprises from 0 to 7%, in particular less than 6%, or less than 5%, or less than 4%, or less than 3%, or less than 2%, or less than 1% by weight of phosphate builder(s).

The detergent composition comprises from 0 to 15%, in particular less than 12%, or less than 10%, or less than 8%, or less than 6%, or less than 4%, or less than 2% by weight of aluminosilicate builder(s). the aluminosilicate builder may comprise zeolite.

The detergent composition may comprise from 0 to 7%, in particular less than 6%, or less than 5%, or less than 4%, or less than 3%, or less than 2%, or less than 1% by weight of polycarboxylic acid(s) and salt(s) thereof.

The detergent composition may comprise from 0 to 7%, in particular less than 6%, or less than 5%, or less than 4%, or less than 3%, or less than 2%, or less than 1% by weight of layered silicate(s).

The detergent compositions of the present invention may comprise from 0 to 20%, in particular less than 15% or 10%, for example less than 5% of sodium carbonate.

### Adjunct Ingredients

The detergent composition may comprise adjunct ingredients The precise nature of these additional adjunct components, and levels of incorporation thereof, will depend on the physical form of the composition and the nature of the operation for which it is to be used. Suitable adjunct materials include, but are not limited to, additional surfactants, flocculating aid, chelating agents, dye transfer inhibitors, enzymes, enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, hydrotropes, processing aids, and/or pigments. In addition to the disclosure below, suitable examples of such other adjuncts and levels of use are found in U.S. Pat. Nos. 5,576,282, 6,306,812 B1 and 6,326,348 B1 that are incorporated by reference. Such one or more adjuncts may be present as detailed below:

SURFACTANT SYSTEM—In addition to the anionic surfactants, the detergent compositions according to the present may comprise nonionic surfactants, cationic surfactants, ampholytic surfactants, zwitterionic surfactants, semi-polar nonionic surfactants and mixtures thereof.

The compositions of the invention may comprise non-ionic surfactant. Where present the non-ionic detersive surfactant(s) is generally present in amounts of from 0.5 to 20 wt %, or from 2 wt % to 4 wt %.

The non-ionic detersive surfactant can be selected from the group consisting of: alkyl polyglucoside and/or an alkyl alkoxylated alcohol; C₁₂-C₁₈ alkyl ethoxylates, such as, NEODOL® non-ionic surfactants from Shell; C₆-C₁₂ alkyl phenol alkoxylates wherein the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA, as described in more detail in U.S. Pat. No. 6,150,322; C₁₄-C₂₂ mid-chain branched alkyl alkoxylates, BAEx, wherein x=from 1 to 30, as described in more detail in U.S. Pat. No. 6,153,577, U.S. Pat. No. 6,020,303 and U.S. Pat. No. 6,093,856; alkylcelluloses as described in more detail in U.S. Pat. No. 4,565,647, specifically alkylpolyglycosides as described in more detail in U.S. Pat. No. 4,483,780 and U.S. Pat. No. 4,483,779; polyhydroxy fatty acid amides as described in more detail in U.S. Pat. No. 5,332,528, WO 92/06162, WO 93/19146, WO 93/19038, and WO 94/09099; ether capped poly(oxyalkylated) alcohol surfactants as described in more detail in U.S. Pat. No. 6,482,994 and WO 01/42408; and mixtures thereof.

The composition optionally may comprise a cationic surfactant. When present, preferably the composition comprises from 0.1 wt % to 10 wt %, or from 1 wt % to 2 wt % cationic detersive surfactant.

Suitable cationic detersive surfactants are alkyl pyridinium compounds, alkyl quaternary ammonium compounds, alkyl quaternary phosphonium compounds, and alkyl ternary sulfonium compounds. The cationic detersive surfactant can be selected from the group consisting of: alkoxylate quaternary ammonium (AQA) surfactants as described in more detail in U.S. Pat. No. 6,136,769; dimethyl hydroxyethyl quaternary ammonium surfactants as described in more detail in U.S. Pat. No. 6,004,922; polyamine cationic surfactants as described in more detail in WO 98/35002, WO 98/35003, WO 98/35004, WO 98/35005, and WO 98/35006; cationic ester surfactants as described in more detail in U.S. Pat. No. 4,228,042, U.S. Pat. No. 4,239,660, U.S. Pat. No. 4,260,529 and U.S. Pat. No. 6,022,844; amino surfactants as described in more detail in U.S. Pat. No. 6,221,825 and WO 00/47708, specifically amido propyldimethyl amine; and mixtures thereof.

Highly preferred cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride. Cationic surfactants such as Praepagen HY (tradename Clariant) may be useful and may also be useful as a suds booster.

ENZYME—Preferably, the composition of the invention further comprises an enzyme. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. The compositions of the present invention may in particular comprise an enzyme having endo-β-1,4-glucanase activity (E.C.3.4.1.4). Non-limiting examples of suitable endo-β-1,4-glucanase enzymes include Celluclean (Novozymes), Carezyme (Novozymes), Celluzyme (Novozymes), Endolase (Novozymes), KAC (Kao), Puradax HA (Genencor), Puradax EG-L (Genencor), the 20 kDa endo-β-1,4-glucanase endogenous to Melanocarpus Albomyces sold under the Biotouch brand (AB Enzymes), and variants and mixtures of these. Suitable enzymes are listed in WO2007/025549A1, page 4 line 15 to page 11 line 2.

When present in the detergent composition, the aforementioned enzymes may be present at levels from about 0.00001% to about 2%, from about 0.0001% to about 1% or even from about 0.001% to about 0.5% or 0.02% enzyme protein by weight of the composition.

The detergent composition may be especially suitable for the use of enzyme which performances are optimized by the presence of calcium ions.

FLOCCULATING AID—The composition may further comprise a flocculating aid. The composition may also be substantially free of flocculating aid. Typically, the flocculating aid is polymeric. Typically the flocculating aid is a polymer comprising monomer units selected from the group consisting of ethylene oxide, acrylamide, acrylic acid and mixtures thereof. Typically the flocculating aid is a polyethyleneoxide. Typically the flocculating aid has a molecular weight of at least 100,000 Da, in particular from 150,000 Da to 5,000,000 Da or even from 200,000 Da to 700,000 Da. Typically, the composition comprises at least 0.3% by weight of the composition of a flocculating aid.

BLEACHING AGENT—The compositions of the present invention may comprise one or more bleaching agents. In general, when a bleaching agent is used, the compositions of the present invention may comprise from about 0.1% to about 50% or even from about 0.1% to about 25% bleaching agent by weight of the subject detergent composition. When present, suitable bleaching agents include bleaching catalysts, suitable bleaching catalysts are listed in WO2008/034674A1, page 46 line 23 to page 49 line 17, photobleaches for example Vitamin K3 and zinc or aluminium phtalocyanine sulfonate; bleach activators such as tetraacetyl ethylene diamine (TAED) and nonanoyloxybenzene sulfonate (NOBS); hydrogen peroxide; pre-formed peracids; sources of hydrogen peroxide such as inorganic perhydrate salts, including alkali metal salts such as sodium salts of perborate (usually mono- or tetra-hydrate), percarbonate, persulfate, perphosphate, persilicate salts and mixtures thereof, optionally coated, suitable coatings including inorganic salts such as alkali metal; and mixtures thereof.

The amounts of hydrogen peroxide source and peracid or bleach activator may be selected such that the molar ratio of available oxygen (from the peroxide source) to peracid is from 1:1 to 35:1, or even 2:1 to 10:1

FLUORESCENT WHITENING AGENT—The composition may contain components that may tint articles being cleaned, such as fluorescent whitening agent. When present, any fluorescent whitening agent suitable for use in a detergent composition may be used in the composition of the present invention. The most commonly used fluorescent whitening agents are those belonging to the classes of diaminostilbene-sulfonic acid derivatives, diarylpyrazoline derivatives and bisphenyl-distyryl derivatives.

Typical fluorescent whitening agents are Parawhite KX, supplied by Paramount Minerals and Chemicals, Mumbai, India; Tinopal® DMS and Tinopal® CBS available from Ciba-Geigy AG, Basel, Switzerland. Tinopal® DMS is the disodium salt of 4,4′-bis-(2-morpholino-4 anilino-s-triazin-6-ylamino)stilbene disulfonate. Tinopal® CBS is the disodium salt of 2,2′-bis-(phenyl-styryl)disulfonate.

FABRIC HUEING AGENTS—Fluorescent whitening agents emit at least some visible light. In contrast, fabric hueing agents alter the tint of a surface as they absorb at least a portion of the visible light spectrum. Suitable fabric hueing agents include dyes and dye-clay conjugates, and may also include pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof. Suitable hueing dyes are listed in WO2008/17570A1, page 4 line 15 to page 11 line 18 and WO2008/07318A2, page 9, line 18 to page 21 line 2.

POLYMERIC DISPERSING AGENTS—the compositions of the present invention can contain additional polymeric dispersing agents. Suitable polymeric dispersing agents, include polymeric polycarboxylates, substituted (including quarternized and oxidized) polyamine polymers, and polyethylene glycols, such as: acrylic acid-based polymers having an average molecular of about 2,000 to about 10,000; acrylic/maleic-based copolymers having an average molecular weight of about 2,000 to about 100,000 and a ratio of acrylate to maleate segments of from about 30:1 to about 1:1; maleic/acrylic/vinyl alcohol terpolymers; polyethylene glycol (PEG) having a molecular weight of about 500 to about 100,000, preferably from about 1,000 to about 50,000, more preferably from about 1,500 to about 10,000; and water soluble or dispersible alkoxylated polyalkyleneamine materials. These polymeric dispersing agents, if included, are typically at levels up to about 5%, preferably from about 0.2% to about 2.5%, more preferably from about 0.5% to about 1.5%.

POLYMERIC SOIL RELEASE AGENT—The compositions of the present invention can also contain polymeric soil release agent. polymeric soil release agent, or “SRA”, have hydrophilic segments to hydrophilize the surface of hydrophobic fibers such as polyester and nylon, and hydrophobic segments to deposit upon hydrophobic fibers and remain adhered thereto through completion of washing and rinsing cycles, thereby serving as an anchor for the hydrophilic segments. This can enable stains occurring subsequent to treatment with the SRA to be more easily cleaned in later washing procedures. Preferred SRA's include oligomeric terephthalate esters; sulfonated product of a substantially linear ester oligomer comprised of an oligomeric ester backbone of terephthaloyl and oxyalkyleneoxy repeat units and allyl-derived sulfonated terminal moieties covalently attached to the backbone; nonionic end-capped 1,2-propylene/polyoxyethylene terephthalate polyesters; an oligomer having empirical formula (CAP)₂ (EG/PG)₅ (T)₅ (SIP)₁ which comprises terephthaloyl (T), sulfoisophthaloyl (SIP), oxyethyleneoxy and oxy-1,2-propylene (EG/PG) units and which is preferably terminated with end-caps (CAP), preferably modified isethionates, as in an oligomer comprising one sulfoisophthaloyl unit, 5 terephthaloyl units, oxyethyleneoxy and oxy-1,2-propyleneoxy units in a defined ratio, preferably about 0.5:1 to about 10:1, and two-end-cap units derived from sodium 2-(2-hydroxyethoxy)-ethanesulfonate; oligomeric esters comprising: (1) a backbone comprising (a) at least one unit selected from the group consisting of dihydroxy sulfonates, polyhydroxy sulfonates, a unit which is at least trifunctional whereby ester linkages are formed resulting in a branched oligomer backbone, and combinations thereof; (b) at least one unit which is a terephthaloyl moiety; and (c) at least one unsulfonated unit which is a 1,2-oxyalkyleneoxy moiety; and (2) one or more capping units selected from nonionic capping units, anionic capping units such as alkoxylated, preferably ethoxylated, isethionates, alkoxylated propanesulfonates, alkoxylated propanedisulfonates, alkoxylated phenolsulfonates, sulfoaroyl derivatives and mixtures thereof. Preferred are esters of the empirical formula:

((CAP)ₐ(EG/PG)_{b}(DEG)_{c}PEG)_{d}(T)ₑ(SIP)_{f}(SEG)_{g}(B)ₕ)

wherein CAP, EG/PG, PEG, T and SIP are as defined hereinabove, DEG represents di(oxyethylene)oxy units, SEG represents units derived from the sulfoethyl ether of glycerin and related moiety units, B represents branching units which are at least trifunctional whereby ester linkages are formed resulting in a branched oligomer backbone, a is from about 1 to about 12, b is from about 0.5 to about 25, c is from 0 to about 12, d is from 0 to about 10, b+c+d totals from about 0.5 to about 25, e is from about 1.5 to about 25, f is from 0 to about 12; e+f totals from about 1.5 to about 25, g is from about 0.05 to about 12; h is from about 0.01 to about 10, and a, b, c, d, e, f, g, and h represent the average number of moles of the corresponding units per mole of the ester; and the ester has a molecular weight ranging from about 500 to about 5,000; and; cellulosic derivatives such as the hydroxyether cellulosic polymers available as METHOCEL® from Dow; the C₁-C₄ alkyl celluloses and C₄ hydroxyalkyl celluloses, see U.S. Pat. No. 4,000,093, issued Dec. 28, 1976 to Nicol et al., and the methyl cellulose ethers having an average degree of substitution (methyl) per anhydroglucose unit from about 1.6 to about 2.3 and a solution viscosity of from about 80 to about 120 centipoise measured at 20° C. as a 2% aqueous solution. Such materials are available as METOLOSE SM100® and METOLOSE SM200®, which are the trade names of methyl cellulose ethers manufactured by Shinetsu Kagaku Kogyo KK.

ENZYME STABILIZERS—Enzymes for use in detergents can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor, such as a boron compound, can be added to further improve stability.

CATALYTIC METAL COMPLEXES—The compositions of the invention may comprise catalytic metal complexes. When present, one type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. No. 5,597,936; U.S. Pat. No. 5,595,967. Such cobalt catalysts are readily prepared by known procedures, such as taught for example in U.S. Pat. No. 5,597,936, and U.S. Pat. No. 5,595,967.

Compositions herein may also suitably include a transition metal complex of ligands such as bispidones (WO 05/042532 A1) and/or macropolycyclic rigid ligands—abbreviated as “MRLs”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include, for example, manganese, iron and chromium. Suitable MRLs include 5,12-diethyl-1,5,8,12-tetraazabicyclo [6.6.2] hexadecane.

Suitable transition metal MRLs are readily prepared by known procedures, such as taught for example in WO 00/32601, and U.S. Pat. No. 6,225,464.

SODIUM SULFATE—the composition preferably comprises sodium sulfate. Sodium sulfate may further help to increase the concentration of anionic surfactant in the aqueous laundry solution while not precipitating the anionic surfactant with calcium. The detergent composition may comprise at least 1% or at least 2% or 5% of sodium sulfate.

SOFTENING SYSTEM—the compositions of the invention may comprise a softening agent and optionally also with flocculants and enzymes; optionally for softening through the wash.

FABRIC SOFTENING BOOSTING COMPONENT—Typically, the composition additionally comprises a charged polymeric fabric-softening boosting component. When the composition comprises clay and silicone particles, preferably, the charged polymeric fabric-softening boosting component is contacted to the clay and silicone in step (ii) of the process for obtaining clay and silicone particles (see above). The intimate mixing of the charged polymeric fabric-softening boosting component with the clay and silicone further improves the fabric-softening performance of the resultant composition.

COLORANT—the compositions of the invention may comprise a colorant, preferably a dye or a pigment. Particularly, preferred dyes are those which are destroyed by oxidation during a laundry wash cycle. To ensure that the dye does not decompose during storage it is preferable for the dye to be stable at temperatures up to 40° C. The stability of the dye in the composition can be increased by ensuring that the water content of the composition is as low as possible. If possible, the dyes or pigments should not bind to or react with textile fibres. If the colorant does react with textile fibres, the colour imparted to the textiles should be destroyed by reaction with the oxidants present in laundry wash liquor. This is to avoid coloration of the textiles, especially over several washes. Particularly, preferred dyes include but are not limited to Basacid® Green 970 from BASF and Monastral blue from Albion.

### Detergent Composition

The detergent composition may be a laundry detergent composition or a fabric care composition. The detergent composition may also be a dish washing composition.

The detergent composition may comprise a solvent. Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

The detergent composition is for example in particulate form, preferably in free-flowing particulate form, although the composition may be in any liquid or solid form. The composition in solid form can be in the form of an agglomerate, granule, flake, extrudate, bar, tablet or any combination thereof. The solid composition can be made by methods such as dry-mixing, agglomerating, compaction, spray drying, pan-granulation, spheronization or any combination thereof. The solid composition preferably has a bulk density of from 300 g/l to 1,500 g/l, preferably from 500 g/l to 1,000 g/l.

The detergent composition may also be in the form of a liquid, gel, paste, dispersion, preferably a colloidal dispersion or any combination thereof. Liquid compositions typically have a viscosity of from 500 mPa·s to 3,000 mPa·s, when measured at a shear rate of 20 s⁻¹ at ambient conditions (20° C. and 1 atmosphere), and typically have a density of from 800 g/l to 1300 g/l. If the composition is in the form of a dispersion, then it will typically have a volume average particle size of from 1 micrometer to 5,000 micrometers, preferably from 1 micrometer to 50 micrometers. The particles that form the dispersion are usually the clay and, if present, the silicone. Typically, a Coulter Multisizer is used to measure the volume average particle size of a dispersion.

The detregent composition may be in unit dose form, including not only tablets, but also unit dose pouches wherein the composition is at least partially enclosed, preferably completely enclosed, by a film such as a polyvinyl alcohol film.

The detergent composition may also be in the form of an insoluble substrate, for example a non-woven sheet, impregnated with detergent actives.

The detergent composition may be capable of cleaning and/or softening fabric during a laundering process. Typically, the detergent composition is formulated for use in an automatic washing machine, although it can also be formulated for hand-washing use.

Method of Laundering Soiled Fabrics

In an other exemplary embodiment of the invention, the invention concerns a method of laundering fabric in an automatic washing machine, which method comprises the steps of:
a) forming an aqueous laundering solution by mixing from 1 l to 40 l of water and a solid detergent composition comprising a surfactant system containing anionic surfactants, said aqueous laundering solution comprising from 200 ppm to 5,000 ppm of the detergent composition;
b) putting in contact soiled fabrics with said aqueous laundering solution; and
c) washing said fabrics in said solution,
wherein during the washing step c), at least 90% by weight of the anionic surfactants of the aqueous laundering solution are present in the aqueous laundering solution at a concentration below the solubility product constant of the corresponding calcium anionic surfactant.

In this method, preferably, the detergent composition is a detergent composition as described above.

During the washing step c), at least 90%, in particular at least 95% or 99% by weight of the anionic surfactants of the aqueous laundering solution are present in the aqueous laundering solution at a concentration below the solubility product constant of the corresponding calcium anionic surfactant. During substantially the whole (at least 90% of the time, or even at least 95% or 99% of the time) washing step c), at least 1%, in particular at least 5% by weight of the anionic surfactants of the aqueous laundering solution are present in the aqueous laundering solution under a micelle form.

The water may have a hardness of between 2 gpg and 20 gpg in particular between 6 gpg and 12 gpg. The water may have a temperature between 10° C. and 50° C., in particular between 15° C. and 35° C.

In this method, the soiled fabrics are washed in an automatic washing machine. The automatic washing machine may be a top loading or a front loading machine typically, the soiled fabric are washed in a front loading machine. The automatic washing machine may comprise a rotatable wash drum. The wash drum may be rotatable around a substantially vertical axis or a round a substantially horizontal axis.

An aqueous laundering solution is formed by mixing water and a solid detergent composition, preferably a detergent composition according to the invention of claim 1. Typically, the aqueous laundering solution is formed inside the washing machine. The aqueous laundering solution may be formed directly in the wash drum. Typically, the solid detergent composition is placed in a detergent dispenser drawer and is mixed with water going through the drawer and then into the drum.

The aqueous laundering solution may comprise from 1 to 40 litres of water, for example from 6 to 35, or from 8 to 30, or even from 9 to 25, or from 10 to 20 litres of water.

The water may be tap water, cold, hot, or a mixture thereof. The water may be heated at a temperature of at least 20° C., or at least 30° C., or even 40° C.

The aqueous laundering solution may be formed by mixing water with from 25 g to 100 g, or from 30 to 95 g, or from 40 to 85 g, or even from 50 to 75 g of solid detergent composition. The aqueous laundering solution may be formed by mixing water with 50 g or less, 45 g or less, or 40 g or less, or 35 g or less, or 30 g or less, or 25 g or less, or 20 g or less, or even 15 g or less, or even 10 g or less of solid detergent composition.

The aqueous laundering solution comprises from 200 ppm to 5,000 ppm of detergent composition. The aqueous laundering solution may comprise at least 250 ppm, or 300 ppm or even at least 350 or 400 or 450 or at least 500 or 600 or 700 ppm of detergent composition. The aqueous laundering solution may comprise at most 4,000 ppm or at most 3,000 ppm or at most 2,000 or 1,000 or 800 ppm of detergent composition.

In particular, the aqueous laundering solution may comprise from 6 to 20 litres of water, in particular from 8 to 15 litres of water, the aqueous laundering solution may be formed with 50 g to 75 g of solid detergent composition, in particular from 60 to 70 g of solid detergent composition, and the aqueous laundering solution may comprise from 500 to 5,000 ppm of detergent composition, in particular from 1,000 to 2,000 ppm of detergent composition.

In particular, the aqueous laundering solution may comprise from 20 to 40 litres of water, in particular from 30 to 35 litres of water, the aqueous laundering solution may be formed with 20 g to 50 g of solid detergent composition, in particular from 25 to 40 g of solid detergent composition, and the aqueous laundering solution may comprise from 400 to 1,000 ppm of detergent composition, in particular from 500 to 700 or 600 ppm of detergent composition.

The concentration of solid detergent composition in the aqueous laundering solution is the one of the main wash cycle. Any input of water during any optional rinsing step(s) is not included when determining the volume of the aqueous laundering solution.

In the method of laundering fabric of the invention, soiled fabrics are put in contact with the aqueous laundering solution. The soiled fabrics may be put in contact directly with the aqueous laundering solution. The soiled fabrics may also be put in contact with the aqueous laundering solution by first putting the soiled fabrics into contact with part of the aqueous laundering solution, (for example by first putting the soiled fabrics in contact with part of the water) and then by adding the remaining part of the aqueous laundering solution (for example adding the detergent composition and the remaining part of water).

The weight ratio of soiled fabric to aqueous laundering solution may be comprised between 1:25 and 1:1, or between 1:20 and 1:1.5 or between 1:15 and 1:2 or even between 1:10 and 1:3.

Typically from 0.01 kg to 2 kg of soiled fabric per litre of aqueous laundering solution is dosed into said aqueous laundering solution. Typically from 0.01 kg, or from 0.02 kg, or from 0.03 kg, or from 0.05 kg, or from 0.07 kg, or from 0.10 kg, or from 0.12 kg, or from 0.15 kg, or from 0.18 kg, or from 0.20 kg, or from 0.22 kg, or from 0.25 kg soiled fabric per litre of aqueous laundering solution is dosed into said aqueous laundering solution.

The soiled fabrics may be soiled clothes, sheets, towels, or mixtures thereof. The soiled fabrics may comprise natural and/or synthetic textiles. The textile may comprise wool, silk, cotton, flax, jute, hemp, modal, acetate, polyester, aramid, acrylic, nylon, spandex, and mixture thereof.

The soiled fabric may be soiled with clay, ground-in dirt, greasy and oily stains, food, body fluids, chocolate, dairy products, grass, blood, egg, cosmetics, cooking oils, animal fats, motor oils, body soils, and mixture thereof.

The soiled fabrics are at least partially washed in the aqueous laundering solution. The fabrics may be washed by keeping them in contact with the aqueous laundering solution for at least 5 seconds, or 30 seconds, or 2 minutes, typically for at least 4 minutes or 6 or 8 or even 10 minutes. Typically, while the fabrics are in contact with the aqueous laundering solution, agitation is provided, for example by rotation of the drum. While the fabrics are in contact with the aqueous laundering solution heating may be provided.

The at least partially washed soiled fabrics may then be rinsed in the automatic washing machine. They may be rinsed at least once or at least twice.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

The following examples are given by way of illustration only and therefore should not be construed to limit the scope of the invention.

### EXAMPLES

### Examples 1-3

### Laundry Detergent Compositions

| | Example 1 | Example 2 | Example 3 |
|---|---|---|---|
| | (concentration | (concentration | (concentration |
| | in weight | in weight | in weight |
| Ingredient | percent) | percent) | percent) |
| Non ionic surfactant | 0-1 | 0-1 | 0-1 |
| Cationic surfactant | 0.5-1 | 0-0.5 | 0-1 |
| LAS | 7 | 6 | 4 |
| MLAS | 0 | 2 | 4 |
| AS | 0 | 1.5 | 3 |
| AES | 3 | 1.5 | 0 |
| Citric acid | 0-0.2 | 0-0.2 | 0-0.2 |
| Silicate | 3-4 | 3-4 | 3-4 |
| Zeolite | 3-4 | 3-4 | 3-4 |
| Na2SO4 | 10 | 12 | 15 |
| Na2CO3 | 35 | 30 | 25 |
| Bleach/NOBS/Bleach | 5-6 | 5-6 | 5-6 |
| system Chelant | | | |
| Enzymes (amylase, | 1-2 | 1-2 | 1-2 |
| cellulase, lipase, | | | |
| mannanase, protease) | | | |
| Polymers | 10-15 | 10-15 | 10-15 |
| Water and | Balance | Balance | Balance |
| miscellaneous | to 100 | to 100 | to 100 |

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detergent composition comprising:
from about 2 to about 30% by weight of anionic surfactants,
from about 0 to about 7% of linear alkylbenzene sulfonate
from about 0 to about 7% of alkyl sulfate,
from about 0 to about 2% of fatty acids,
from about 0 to about 5% of phosphate builder,
from about 0 to about 15% of aluminosilicate builder,
wherein the weight ratio of linear alkylbenzene sulfonate to the total amount of anionic surfactant is comprised between about 0 and about 0.65,
wherein the weight ratio of alkyl sulfate to the total amount of anionic surfactant is comprised between about 0 and about 0.65.

2. The detergent composition according to claim 1 comprising:
from about 0 to about 7% of citric acid, and
from about 0 to about 7% of layered silicate.

3. The detergent composition according to claim 1, wherein the composition comprises from about 4 to about 20% of anionic surfactants.

4. The detergent composition according to claim 1 wherein the weight ratio of alkylbenzene sulfonate to the total amount of anionic surfactant is comprised between about 0 and about 0.5, and wherein the weight ratio of alkyl sulfate(s) to the total amount of anionic surfactant is comprised between about 0 and about 0.5.

5. The detergent composition according to claim 1 comprising from about 0 to about 5% of alkylbenzene sulfonate.

6. The detergent composition according to claim 1 comprising from about 0 to about 5% of alkyl sulfate.

7. The detergent composition according to claim 1 comprising an enzyme chosen from lipase, protease, amylase, and mixtures thereof.

8. The detergent composition according to claim 1 further comprising sodium sulphate.

9. A method of laundering soiled fabrics in an automatic washing machine, the method comprises the steps of:
a) forming an aqueous laundering solution by mixing from about 1 l to about 40 l of water and a solid detergent composition comprising a surfactant system containing anionic surfactants, said aqueous laundering solution comprising from about 200 ppm to about 5,000 ppm of the detergent composition;
b) putting in contact soiled fabrics with said aqueous laundering solution; and
c) washing said soiled fabrics in said aqueous laundering solution,
wherein during the washing step c), at least about 90% by weight of the anionic surfactants of the aqueous laundering solution are present in the aqueous laundering solution at a concentration below the solubility product constant of the corresponding calcium anionic surfactant.

10. The method according to claim 9, wherein during the washing step c) at least about 95% by weight of the anionic surfactants of the aqueous laundering solution are present in the aqueous laundering solution at a concentration below the solubility product constant of the corresponding calcium anionic surfactant.

11. The method according to claim 9, wherein during the washing step c), at least about 1% by weight of the anionic surfactants of the aqueous laundering solution are present in the aqueous laundering solution under a micelle form.

12. The method according to claim 9, wherein the water has a hardness of between about 2 gpg and about 20 gpg.

13. The method according to claim 9, wherein the aqueous laundering solution has a temperature of between 10° C. and 50° C.

14. The method according to claim 9, wherein the detergent composition is a detergent composition comprising:
from about 2 to about 30% by weight of anionic surfactants,
from about 0 to about 7% of linear alkylbenzene sulfonate
from about 0 to about 7% of alkyl sulfate(s),
from about 0 to about 2% of fatty acids,
from about 0 to about 5% of phosphate builder,
from about 0 to about 15% of aluminosilicate builder,
wherein the weight ratio of linear alkylbenzene sulfonate to the total amount of anionic surfactant is comprised between about 0 and about 0.65,
wherein the weight ratio of alkyl sulfate to the total amount of anionic surfactant is comprised between about 0 and about 0.65.
